(19) United States
(12) Patent Application Publication
(10) Pub. No.: US 2008/0140574 A1
(43) Pub. Date: Jun. 12, 2008

(54) Enabling an enhanced function of an electronic device

(76) Inventors: Laurence B. Boucher, Saratoga, CA (US); Esther Lee, Saratoga, CA (US); Richard Blackborow, Saratoga, CA (US); Barry Haaser, Morgan Hill, CA (US); Joseph L. Gervais, Fremont, CA (US); Benjamin L. Dagana, Norristown, PA (US); Peter Craft, San Francisco, CA (US)

Correspondence Address: MARK A LAUER, 6601 KOLL CENTER PARKWAY, SUITE 245, PLEASANTON, CA, 94566, US

(21) Appl. No.: 11/985,948

(22) Filed: Nov. 19, 2007

Related U.S. Application Data
(62) Division of application No. 10/289,977, filed on Nov. 6, 2002.

(51) Int. Cl. G06Q 99/00

(52) U.S. Cl. 705/65

(57) ABSTRACT

An electronic device (for example, a NIC card) can perform a base function (for example, “dumb” NIC functionality) and also has specialized hardware for performing an enhanced function (for example, TCP offload functionality). Initially, the electronic device is capable of performing the base function but the enhanced function is disabled. The electronic device is priced to be price competitive with other devices that perform the base function but not the enhanced function. By this pricing, large numbers of the electronic devices are disseminated into the marketplace. Once an electronic device has been disseminated and supplied to a user, the user can make an additional payment to have the enhanced function enabled. In one embodiment, a user who pays for the enhanced functionality accesses a web-based license manager and receives a license key. The license key is usable to write a capabilities code into the electronic device that enables the enhanced function.

### CROSS-REFERENCE TO RELATED APPLICATIONS

The present application claims the benefit under 35 USC § 120 of (is a divisional of) U.S. patent application Ser. No. 10/289,977, filed Nov. 6, 2002, which is incorporated by reference herein.

### BACKGROUND INFORMATION

In the electronics industry, there exist what may be considered established markets for particular classes of electronic products. Within such a class, the functionality of products from different manufacturers may be quite similar. Due to the similarity in functionality and due to the numerous manufacturers, there may be strong price competition among the products in such a class. This price competition can drive down profit margins. Commercial success in such a product area therefore may be heavily dependent on driving per unit manufacturing cost down and running an efficient business, and may be less dependent on technical innovation.

The so-called “dumb” NIC (network interface card) might be considered one such class of electronic device. A NIC, in its most common form, is an expansion card for a host computer. The NIC typically has a card edge connector for coupling to a connector on a motherboard of a host computer. The NIC also has one or more network interface ports for coupling to network cables such that the NIC can be coupled to a network such as an Ethernet LAN (local area network). Adding the NIC card to the host computer allows the host computer to receive communications from the LAN and to transmit communications to the LAN. In a “dumb” NIC, an incoming Ethernet frame is typically received onto the NIC via a network interface port, Media Access Control (MAC) circuitry on the NIC then typically performs Ethernet processing on the frame, and the resulting information is sent from the NIC to the host computer. A stack of the protocol processing layers in the host computer receives the information and performs higher level protocol processing, such as, network layer processing (for example, IP protocol processing) and transport layer processing (for example, TCP protocol processing). The host computer therefore typically performs a significant amount of network and transport layer protocol processing on each incoming frame. In the transmit direction, the stack in the host computer also typically performs significant transport and network layer processing. After the host performs this transport and network layer processing, the host computer sends the resulting information to the MAC circuitry on the NIC for transmission onto the network.

Such “dumb” NIC cards are available in the consumer market from a large number of manufacturers, and therefore are considered to be one “class” of product in the context of the discussion above. In the environment of such an established product class, it is often difficult to gain rapid market acceptance of a new device having improved performance where the cost of the new device with the enhanced performance is significantly higher than the prevailing cost for the commodity item. This may be true even if the economic benefit to the consumer of using the new device would actually more than compensate for the added cost of purchasing the new device.

An INIC (Intelligent Network Interface Card) available from Alacritech Inc. of San Jose, Calif. is an example of one such new device. Due in part to providing specialized hardware on the card, the Alacritech INIC achieves significant performance improvements in comparison to standard dumb NIC cards. A standard dumb NIC such as, for example, the PRO/1000 available from Intel achieves a performance/efficiency index of 12.06. The 1000x1 INIC available from Alacritech Inc., in comparison, was tested to have a performance/efficiency index of 195.35. Providing the additional specialized hardware on the Alacritech card, however, involves a significant cost. This additional hardware cost increases per unit manufacturing cost of the card. When this added cost is passed along to the customer in the form of increased product price, customers sometimes elect to purchase the lower performance commodity item with which they have more familiarity. Had such customers tried the more expensive new device, the customers may have decided that the improved performance warranted paying the increased amount for the INIC, but due to unfamiliarity with the new enhanced product, and without the option to try it, the customers elected to stay with the lower priced and more familiar commodity product. The increased cost of providing the additional specialized hardware therefore serves as a sort of barrier to, selling the new enhanced product into the market for the commodity item. Further barriers exist, in that the commodity product is frequently integrated into more complex systems, forcing the user to replace the integrated functionality to use the enhanced functionality. For example, in the NIC market, two further levels of integration occur—first where the NIC controller is integrated into the motherboard as a chip level solution, and second where the NIC controller is integrated into the server chipset as an Intellectual Property level solution. Past attempts at solving the problem only address some of the issues. To address volume related silicon costs, chips are sometimes built with enhanced functionality so the enhanced functionality shares a higher volume. In the packaging of the chip at manufacturing time, the enhanced functionality is only activated on a percentage of the chips, through the use of bond out options, where one package has the functionality active, and a second package does not. A solution to this problem of barrier to entry for an enhanced product is desired.

### SUMMARY

An electronic device (for example, a NIC card) is capable of performing a base function (for example, “dumb” NIC functionality). The electronic device also has specialized hardware for performing an enhanced function (for example, a TCP offload function). Initially, the electronic device is capable of performing the base function but the enhanced function is disabled. The electronic device is priced to be price competitive with other devices on the market that perform the base function but cannot perform the enhanced function. By this pricing, large numbers of the electronic devices are sold or otherwise disseminated into the marketplace.

Once an electronic device has been supplied to a user, the user can elect to make an additional payment to have the enhanced function enabled. The amount of the additional payment can be set such that the sum of the additional payments made more than compensates for the cost of having to provide the specialized hardware to other users who do not elect to make the additional payment. In one embodiment, a user who pays for the enhanced functionality accesses a web-based license manager, makes the additional payment, and receives a license key. The user then uses the license key to write a capabilities code into the electronic device. The writing of the capabilities code enables the electronic device to perform the enhanced function.

The method of receiving additional compensation in return for allowing the enhanced function of an electronic device to be enabled does not require that the electronic device be sold, distributed, or otherwise supplied to an end-user with the enhanced function disabled. The electronic device may, for example, be supplied to a user with the enhanced function enabled for a trial period. The user can arrange to have the enhanced function enabled after the trial period has expired by agreeing to make an additional payment. Additional payment for having the enhanced function enabled can be required of either a manufacturer of the electronic device, a distributor or reseller of the electronic device, or an end-user of the electronic device. Proceeds from the additional payments can be received by a manufacturer of the electronic device, and/or a distributor or reseller of the electronic device, and/or a holder of intellectual property in the electronic device.

Other embodiments and details are also described below. This summary does not purport to define the invention. The claims, and not this summary, define the invention.

### BRIEF DESCRIPTION OF THE DRAWINGS

FIG. 1 is a diagram of a method in accordance with an embodiment of the present invention wherein an enhanced function of an electronic device is enabled if a user of the electronic device agrees to make an additional payment.

FIG. 2 is a simplified diagram of one particular system capable of carrying out the method of FIG. 1.

FIG. 3 is a simplified diagram of the various fields of information within EEPROM 214 of the electronic device 200 of FIG. 2.

FIG. 4 is a simplified diagram of specialized hardware (capable of performing an enhanced function) integrated into an I/O controller integrated circuit in accordance with one embodiment of the present invention.

### DETAILED DESCRIPTION

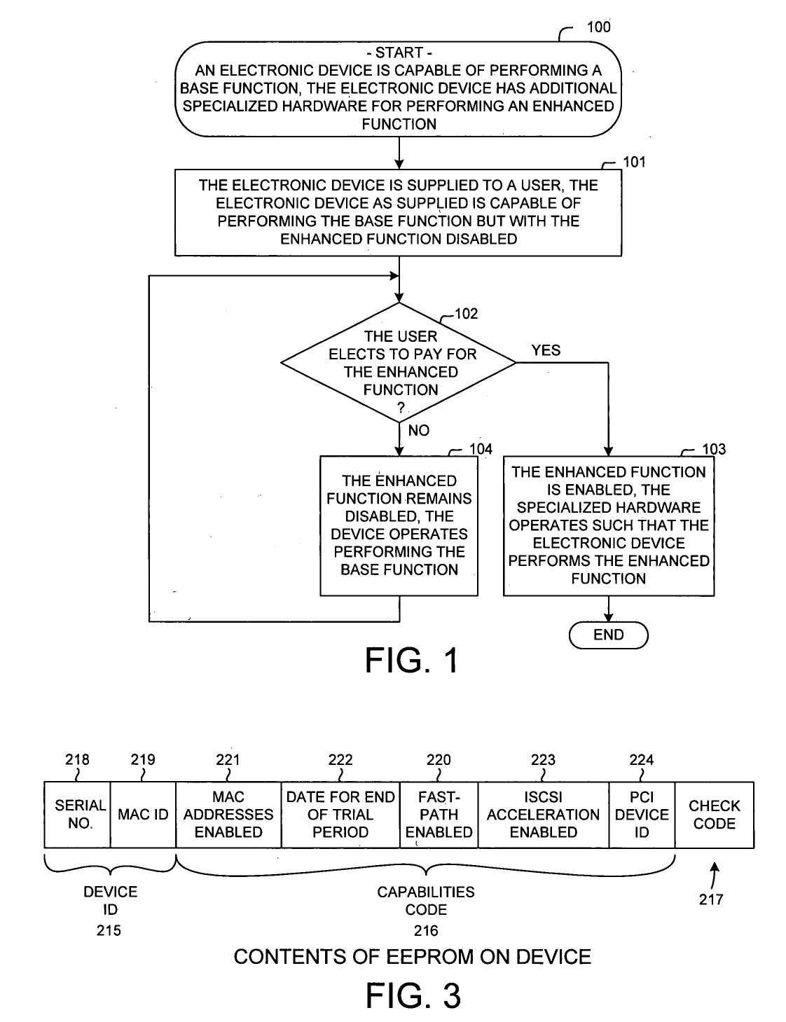

FIG. 1 is a flowchart of a method in accordance with one embodiment of the present invention. An electronic device is capable of performing a base function. In one example, the electronic device is a NIC card and the base function is “dumb” NIC card functionality in that the NIC card does not perform substantial TCP protocol processing on frames containing a TCP header that are received onto the NIC card from a network. The base function involves interfacing with a stack executing on a host computer such that the stack performs TCP protocol processing on such frames.

In addition to the electronic device having the ability to perform the base function, the electronic device includes specialized hardware which if enabled allows the electronic device to perform an enhanced function. In the example where the electronic device is a NIC, the enhanced function might be a “TCP offload” function. When the NIC performs the TCP offload function, the NIC performs all or substantially all TCP protocol processing on at least some incoming frames (frames that have a TCP header) such that the host stack does no or substantially no TCP protocol processing on those frames. The initial capability of the electronic device to perform both the base function, as well as the enhanced function if the electronic device is appropriately enabled, is illustrated in FIG. 1 by reference numeral 100.

The electronic device is sold into the marketplace or is otherwise supplied (step 101) to a user. As supplied to the user, the electronic device is capable of performing the base function but has its enhanced functionality disabled (not enabled). The electronic device may, for example, be sold to the user by offering the electronic device for sale at a price to compete with other devices on the market that perform the base function but do not perform the enhanced function. By pricing the electronic device to compete with other devices that perform the base function but not the enhanced function, it is believed that barriers to selling a more expensive product with enhanced functionality will be reduced or removed. The electronic device will be more readily sold in great numbers than had the electronic device been more highly priced as a device that performs the enhanced function. In this way, the electronic device is disseminated into the marketplace and reaches the user. In the example of the electronic device being a NIC card and the base function being “dumb” NIC functionality, the user can use the electronic device as a “dumb” NIC. The enhanced “TCP offload” function is, however, disabled.

After the electronic device has been supplied to the user, the user may elect (step 102) to enter into an agreement to make an additional payment in order to be able to have the electronic device perform the enhanced function. In the example of the electronic device being a NIC and the base function being “dumb” NIC operation, the user may contract with the manufacturer of the electronic device (or with a distributor of the electronic device) to have the enhanced function enabled.

If the user agrees to make additional payment, then the enhanced function is enabled (step 103). Once enabled, the specialized hardware of the electronic device operates such that the electronic device performs the enhanced function. In the case of the electronic device being a NIC, the specialized hardware may include a hardware sequencer that preprocesses an incoming Ethernet frame. The hardware sequencer makes an initial determination as to whether the frame is one for which TCP processing can be handled by the NIC. The hardware sequencer places an indication of this initial determination onto a queue along with a buffer descriptor that identifies where in a memory on the NIC card the associated frame will be stored. The specialized hardware may also include a processor that retrieves the initial determination from the queue and performs IP and TCP protocol processing on the associated frame such that the data payload (free of IP and TCP headers) of a session layer message is moved directly from the NIC card into a destination on a host computer. The destination may be a location in memory on the host identified by an application executing on the host computer. The processor of the NIC and the software it executes are structured such that the processor receives the information from the queue without being interrupted, without having to save the contents of its internal registers in a context switch, and without having to execute out of non-zero-wait-state memory. The specialized hardware also includes additional memory in embodiments where such additional memory is required to perform the enhanced function. Additional memory may, for example, be required to store TCBs used to keep track of protocol processing of offloaded TCP connections. Additional memory may also be required to buffer frames of offloaded TCP connections. The specialized hardware may also include a Direct Memory Access (DMA) controller that moves the data payload from the NIC to the destination in the host computer. In one embodiment, the same specialized hardware can perform either the base function or the enhanced function. For additional information on one embodiment of such specialized hardware, see: 1) U.S. Pat. No. 6,427,173; and 2) U.S. Pat. No. 6,247,060 (the subject matter of these two patents is incorporated herein by reference).

If, on the other hand, the user does not elect (step 104) to make the additional payment, then the enhanced function remains disabled (not enabled). The electronic device continues to operate with its base function capability but with the enhanced functionality disabled.

In accordance with the method of FIG. 1, an electronic device with specialized hardware for performing an enhanced function is disseminated into the marketplace by selling the electronic device at a price point that approximates the price point of other devices that perform the base function but not the enhanced function. Pricing the electronic device in this fashion may cut into the profit margin on the sale of the electronic device because providing each electronic device involves the added expense of providing the specialized hardware. In accordance with some embodiments, the electronic device may be sold at no profit or at a small loss in order to promote dissemination of the electronic device.

Then, once the electronic device has been disseminated into the marketplace, the enhanced functionality can be offered at a second price point appropriate for devices capable of performing the enhanced function. In cases where there is less competition for devices capable of performing the enhanced function, the second price point may exceed the cost of providing the specialized hardware on the electronic device. The second price point may therefore be set so that more lucrative sales of the enhanced functionality can be made to: 1) recover the cost of providing the specialized hardware to those users who did not elect to have the enhanced function enabled, and 2) provide an additional profit. By using this method, a manufacturer and/or distributor of the electronic device can get electronic devices distributed into the marketplace by selling at a first price point, and can recoup the cost of getting those electronic devices so distributed by setting a second price point for providing the enhanced functionality.

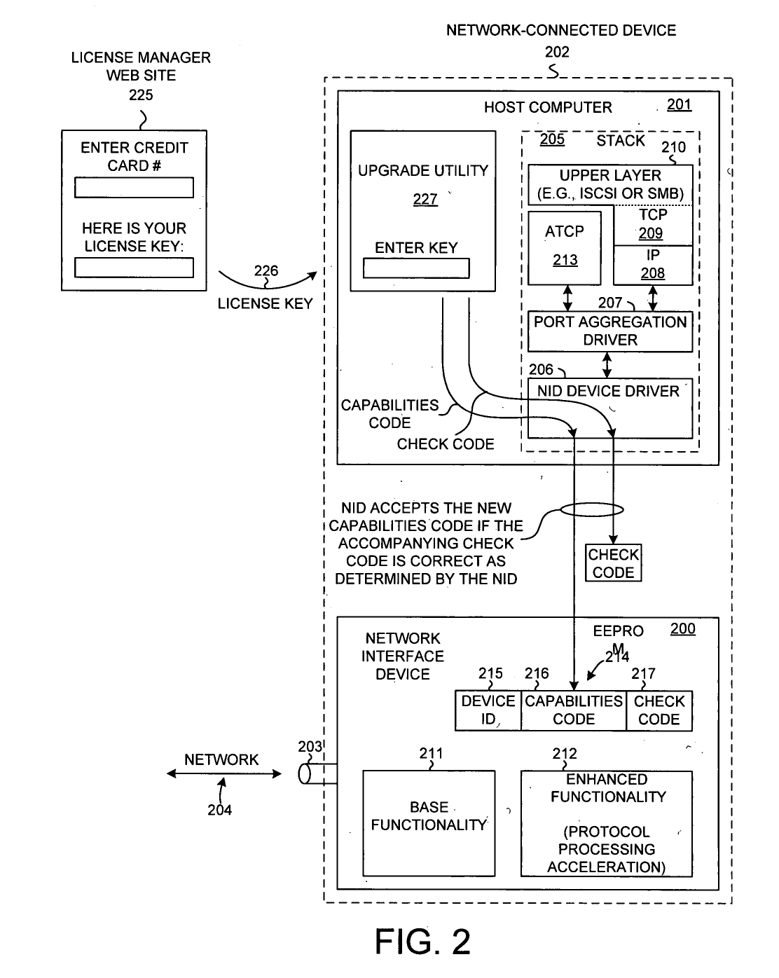

FIG. 2 is a diagram of a specific embodiment in accordance with an embodiment of the present invention. In the example of FIG. 2, an electronic device 200 is a network interface device such as, for example, an intelligent NIC (INIC) or what is sometimes called a “TCP offload device” or a “TCP offload engine” (TOE). Electronic device 200 is coupled to a host computer 201. Electronic device 200 and host computer 201 are together considered a network-connected device 202. Electronic device 200 includes a network interface port 203. Host computer 201 receives network communications from a network 204 via port 203 and electronic device 200. Host computer 201 also transmits network communications onto network 204 via electronic device 200 and port 203.

Host computer 201 includes a processor that executes a protocol processing stack 205. In the simplified diagram of FIG. 2, stack 205 includes a network interface device (NID) driver 206, a port aggregation driver portion 207, an IP protocol processing layer portion 208, a TCP protocol processing layer portion 209, and an upper protocol processing layer portion 210. Upper protocol processing layer portion 210 may, for example, be an ISCSI protocol processing layer. If the OSI model is being used to describe stack 205, then upper protocol processing layer portion 210 may be considered to include session layer processing and may also include presentation and application layer processing. If the TCP/IP model is being used to describe stack 205, then upper protocol processing layer portion 210 may be considered to be an application layer.

In the example of FIG. 2, electronic device 200 has a base function of operating as a “dumb” NIC for host computer 201. This base function of electronic device 200 is represented by block 211. Electronic device 200 also has an enhanced function of performing a TCP offload function. In one embodiment, certain selected types of commonly occurring network TCP/IP communications are handled by electronic device 200 in a “fast-path” such that all or substantially all IP and TCP protocol processing of these communications are handled by electronic device 200. Other types of less commonly occurring network communications such as, for example, non TCP/IP communications and error conditions, are handled by stack 205 in a “slow-path” in a more conventional manner.

To facilitate this “fast-path” TCP offload processing, specialized hardware is provided on electronic device 200. This specialized hardware, and the enhanced function it allows the electronic device 200 to perform, is represented in FIG. 2 by block 212. In one embodiment, this specialized hardware includes preprocessing hardware circuitry (for example, a sequencer) that analyzes an incoming Ethernet frame from network 204 and makes an initial determination whether the incoming frames should be handled in fast-path or not. The preprocessing hardware places an indication of its initial determination (also called an “attention bit”) onto a hardware queue. A “buffer descriptor” identifying where in memory on the electronic device the frame can be found is also placed onto the queue. In the specific example of FIG. 2, the specialized hardware further includes a specialized (non-general purpose) processor that retrieves the indication of the initial determination from the queue. If the indication is that the associated frame is suitable for fast-path processing, then the specialized processor performs IP and TCP protocol processing on the frame such that stack 205 of host computer 201 is offloaded of these tasks. For additional information on the composition of one particular embodiment involving a receive sequencer that performs preprocessing, a queue manager, and a specialized processor that performs TCP and IP offload processing, see: 1) U.S. Pat. No. 6,427,173; and 2) U.S. Pat. No. 6,247,060 (the subject matter of these two patents is incorporated herein by reference). To support this “fast-path” TCP offload capability, a portion of specialized protocol processing code 213 (denoted ATCP) is incorporated into stack 205. For additional information on one embodiment of stack 205 and ATCP portion 213, see: 1) U.S. patent application Ser. No. 10/208,093, filed Jul. 29, 2002, entitled “Protocol Processing Stack For Use With Intelligent Network Interface Device”, by Peter Craft et al.; 2) U.S. Pat. No. 6,247,060, and 3) U.S. Published Patent Application 20010047433, published Nov. 29, 2001 (the subject matter of these documents is incorporated herein by reference). For additional details on a port aggregation driver, see U.S. patent application Ser. No. 09/801,488, filed Mar. 7, 2001, including the information on its Compact Disc. Appendix (the subject matter of which is incorporated herein by reference).

Electronic device 200 includes a nonvolatile memory 214, which in this specific embodiment is an electrically-erasable programmable read only memory (EEPROM). FIG. 3 is a more detailed diagram of the contents of nonvolatile memory 214. Nonvolatile memory 214 includes a device identifier portion 215, a capabilities code portion 216, and a check code portion 217.

Device identifier portion 215 includes a serial number that uniquely identifies the particular electronic device. Device identifier portion 215 also may include other identification information 219 such as, for example, a list of all the MAC addresses of the electronic device.

Capabilities code portion 216 indicates whether the electronic device is enabled to perform the enhanced function. In the example of FIG. 3, capabilities code portion 216 includes a “fast-path enabled” field 220. If a bit in the “fast-path enabled” field is set, then electronic device 200 is enabled to perform the enhanced function. If the bit is not set, then electronic device 200 is not enabled to perform the enhanced function. In the example of FIG. 3, capabilities code portion 216 further includes a “MAC addresses enabled” field 221, a “date for end of trial period” field 222, an “ISCSI acceleration enabled” field 223, and a “PCI device ID” field 224.

Check code portion 217 contains a security check code that is a proprietary function of the contents of the device identifier portion 215 and capabilities code portion 216. In one example, the check code is a 4-byte keyed Message Authentication Code. The check code may be the keyed-Hash Message Authentication Code (HMAC), specified in FIPS PUB198. This code relies a secret key in conjunction with an underlying cryptographic hash-function (such as SHA-1) to produce a MAC.

When EEPROM 214 is written or when the contents of EEPROM 214 is read and used by electronic device 200, electronic device 200 calculates the check code value using the proprietary function. For example, when electronic device 200 receives from host computer 201 a capabilities code value to write into the capabilities code field of EEPROM 214, the electronic device calculates a check code for the device ID and capabilities code to be written. If the check code calculated does not match a check code received from host computer 201 along with the capabilities code to be written, then electronic device 200 does not allow EEPROM 214 to be written. Similarly, when EEPROM 214 is being read by electronic device 200, the electronic device calculates a check code value using the values stored in the device ID field 215 and the capabilities code field 216. If the calculated check code value does not match the check code value stored in field 217, then the enhanced function is not enabled.

In an initial step, multiple copies (i.e., instances) of electronic device 200 are distributed into the marketplace or otherwise supplied to users. The capabilities codes of these electronic devices are set such that the electronic devices can perform the base function, but so that the electronic devices are not enabled to perform the enhanced function. Electronic device 200 may be marketed, advertised, and priced to compete aggressively with a class of “dumb” NIC cards that do not perform the TCP offload enhanced function. Each electronic device 200 has an amount of specialized hardware that allows the electronic device 200 to perform the enhanced function, but the electronic device is nevertheless marketed, advertised, and priced to compete with the class of “dumb” NIC cards.

A user who purchases electronic device 200 receives both the electronic device 200 as well as associated software for execution on host computer 201. The associated software supplied may, for example, include NID device driver 206, port aggregation driver 207, and ATCP portion 213. Each time electronic device 200 is powered up, the electronic device 200 reads EEPROM 214 and from the capabilities code field 216 determines that the enhanced function is disabled. The electronic devices are therefore able to perform the base function but not the enhanced function.

Once electronic devices have been supplied to users in this manner, an individual user can agree to pay an additional sum to be able to use the enhanced function. In the presently described example, the user accesses an authorized web site 225 (see FIG. 2). Web site 225 lists a number of different enhanced function offerings, each with its own listed price. One enhanced function offering may, for example, be a free trial or free demonstration period during which the user can arrange to enable fast-path TCP offload capability. A second enhanced function offering may, for example, be unlimited fast-path TCP offload capability for an unlimited number of TCP/IP connections for an unlimited time. A third enhanced function offering may, for example, be ISCSI acceleration in addition to fast-path TCP offload capability.

If the user agrees to the commercial terms associated with an enhanced function offering (for example, the user agrees to pay an additional amount), then the user is given an appropriate license key 226. In one example, web site 225 provides a way for the user to interact with a commercially available license manager program. The user may, for example, use a web browser to enter a credit card number to make the additional payment, and may also enter some other information such as the device ID of the electronic device and the customer's name. The license manager then displays the license key on the web site. A suitable license manager program may, for example, be available from Rainbow Technologies, Inc. of 50 Corporate Drive, Irvine, Calif. 92618.

In the present example, the host software provided with electronic device 200 includes an upgrade utility program 227. Upgrade utility program 227 prompts the user for the license key 226. The user enters the license key 226 into a dialog box, and upgrade utility program 227 converts license key 226 into a capabilities code. In one embodiment, license key 226 includes an encrypted form of the device ID supplied by the user, a capabilities code and a check code, where the check code is a proprietary function of the device ID and the capabilities code. The upgrade utility program 227 decrypts the license key to recover the device ID, capabilities code and check code. Once the device ID, capabilities code and check code are recovered, they are passed to network interface device driver 206, which makes a request to electronic device 200 to write them into the EEPROM 214. Electronic device 200 first calculates a check code value from the device ID and capabilities code that are being passed to it. If this check code value is identical to the check code being passed to it, electronic device 200 then makes sure that the device ID being passed matches the device ID found in device ID field 215. Only if both of these tests pass does electronic device 200 allow the capabilities code and the new check code to be written into EEPROM 214.

In this way, a user can pay an additional amount to receive a license key that the user can then use to enable a selected enhanced function. Use of electronic device 200 to perform the selected enhanced function may be priced such that the additional payments from users who elect to pay for enhanced functionality exceeds the aggregate cost of providing the specialized hardware in the electronic devices of those many other users who do not elect to pay more for the enhanced function. Two price points can therefore be set, one for the class of “dumb” network interface device cards, and another for another class of TCP offload devices. The first price point can be used to penetrate the market for the existing class of product, whereas the second price point can be used to recover the cost of penetrating that market. In some cases, a higher price can be commanded for electronic device 200 even though electronic device 200 has the enhanced function disabled because there is value in the ability of electronic device 200 to be quickly and easily enabled to perform the enhanced function. In the case where electronic device 200 is a NIC card, the electronic device with the enhanced function disabled may be advertised as “TOE ready” (TCP offload engine ready) and for this reason may command a higher price than other dumb NIC cards on the market that cannot be enabled to perform the enhanced TCP offload function.

In the description above, electronic device 200 is supplied to users with the enhanced function disabled. This need not be the case. In one example, the value in the “date for end of trial period” field 222 is set for a date after the date the electronic device is supplied to the users. The enhanced function, in this case the fast-path TCP offload capability, is enabled up until the “date for end of trial period” date arrives. Electronic device 200 has the ability to read the current date. If the current date is after the “date for end of trial period”, then the electronic device disables the enhanced function or warns the user that the trial period is coming to an end. Electronic device 200 is distributed into the market in this fashion such that the user can try out the enhanced function for an initial trial period. In another embodiment, electronic device 200 is distributed as a “dumb” NIC with an offer to temporarily activate enhanced functionality, or an offer of a low-cost activation of the enhanced functionality.

Although an embodiment of the present invention is described here in connection with a license manager, an upgrade utility, and an EEPROM on the electronic device, it is to be understood that an enhanced function of an already-distributed electronic device can be selectively enabled or disabled in numerous other ways. The mechanism for enabling the enhanced function need not be so secure that it cannot be circumvented by a dedicated intelligent hacker. The method set forth has substantial use even if a few sophisticated hackers can manage to enable enhanced functionality without authorization. Rather than an end-user arranging to make payment to enable the enhanced functionality of an individual electronic device, many electronic devices can be distributed by a third party distributor. This third party distributor may pay a license fee such that the electronic devices the third party distributor sells or distributes have the enhanced function enabled. A second third party distributor who does not elect to pay the license fee can sell or distribute otherwise identical electronic devices but those electronic devices would not have the enhanced function enabled. The additional payment for having the enhanced function enabled can therefore be exacted from any desired party in the distribution chain of the electronic device. The additional payment may be received by the manufacturer of the electronic device. Alternatively, the additional payment may be received by another party in the distribution chain (for example, a large distributor). The additional payment may be received by another party not in the distribution chain such as, for example, a holder of intellectual property rights in the electronic device. Either a party such as the manufacturer of the chip set or another third party such as a distributor or a holder of intellectual property can control enabling the enhanced function and can receive the associated additional compensation. In one example, the manufacturer of the electronic device and a distributor of the electronic device and a holder of intellectual property in the electronic device share the proceeds associated with providing the enhanced function.

Although stack 205 is shown executing on host computer 201 in the example of FIG. 2, it is understood that electronic device 200 may be fashioned such that the functions of stack 205 are carried out on electronic device 200. For example, in one embodiment a general purpose processor executes a stack that performs TCP and IP protocol processing functions. This general purpose processor is part of electronic device 200. If electronic device 200 is a NIC card, then the general purpose processor is present on the NIC expansion card along with the rest of the NIC circuitry. If the card performs all TCP and IP protocol processing functions (both normal communications as well as error conditions) for TCP/IP network communications passing through the card, then the card is sometimes called a “full TCP offload” device.

Although an enhanced function can be enabled and/or disabled by writing a capabilities code into an electronic device as set forth above, there are other ways of controlling the enabling and/or disabling of an enhanced function. In one embodiment, for example, host stack 205 (see FIG. 2) gives control of individual TCP connections to network interface device 200 in what is called a “hand out” process. If stack 205 hands out control of a TCP connection, then network interface device 200 can perform the enhanced TCP offload function for communications occurring over that TCP connection. If, on the other hand, stack 205 does not hand out control of the TCP connection to network interface device 200, then network interface device 200 operates as a dumb NIC and passes individual TCP/IP packets associated with the TCP connection to the host for TCP protocol processing on the host. In one embodiment in accordance with the present invention, if the user does not agree to pay the additional compensation, then the software executing on the host does not hand out control of TCP connections to network interface device 200. The enhanced TCP offload functionality of network interface device 200 therefore is not enabled because control of TCP connections are never handed over to network interface device 200. It is therefore seen that the writing of a capabilities code into an electronic device is not required in order to be able to control whether the electronic device can perform the enhanced function.

Although the invention is described above in connection with the electronic device being a network interface card (NIC), this is done only for illustrative purposes. The above-described method of selectively enabling an enhanced function is applicable to a number different types of electronic devices. In one embodiment, the electronic device is an integrated circuit that is part of a microprocessor chipset such as the Intel 815 chipset.

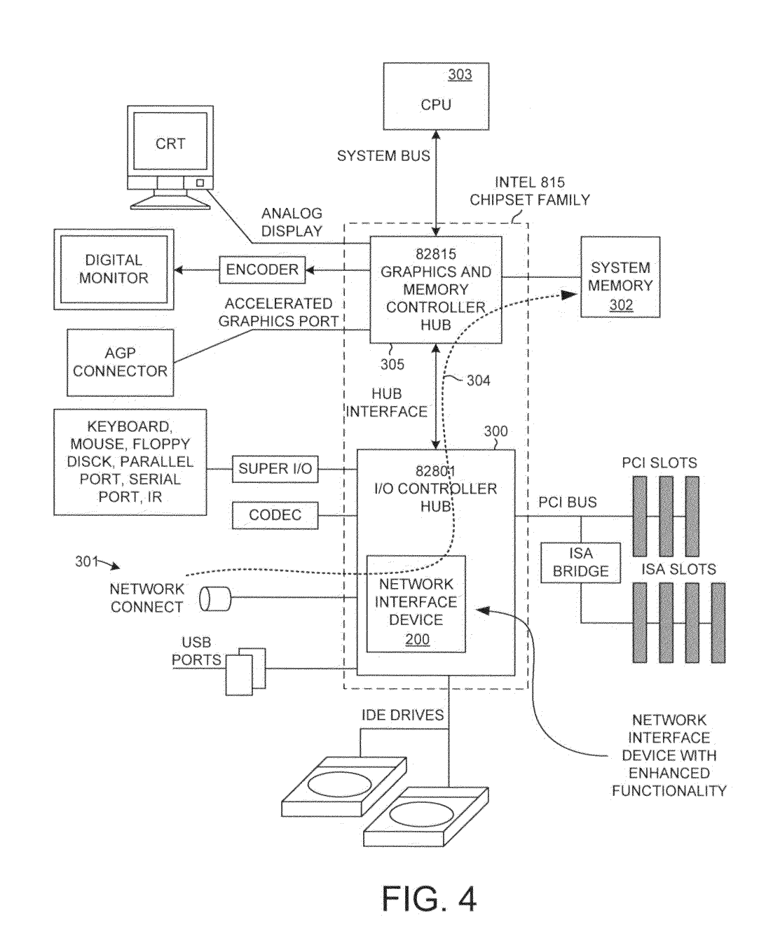

FIG. 4 is a diagram showing an integrated circuit 300 (the Intel 82801 I/O Controller Hub) that is part of the Intel 815 chipset. In accordance with an embodiment of the present invention, specialized network interface device circuitry 200 capable of performing an enhanced TCP offload function is incorporated into integrated circuit 300. The Intel 82801 integrated circuit 300, including specialized network interface device circuitry 200, is manufactured in volume and distributed. If a user does not agree to pay the additional amount for use of the enhanced TCP offload function, then the I/O controller hub integrated circuit 300 performs its base network interface function but is not enabled to perform the enhanced function. If, on the other hand, the user agrees to pay an additional amount for the enhanced functionality, then the specialized network interface device circuitry 200 is enabled to perform the enhanced TCP offload function. In the present example, specialized network interface device circuitry 200 performs the TCP offload function such that the data payload of a multi-packet session layer message is retrieved from network 301 in the form of multiple TCP/IP packets, and is written into a destination in system memory 302 without any TCP or IP headers, and without a protocol processing stack executed by CPU 303 doing any or substantially any TCP protocol processing on the various TCP/IP packets. Arrow 304 represents the path taken by the session layer data payload on its way to the destination in system memory 302. By incorporating the specialized network interface device circuitry 200 into the I/O controller hub integrated circuit 300 in this way, the specialized circuitry for performing the enhanced TCP offload function is disseminated into the motherboards of a great many computers without having to overcome market resistance associated with introducing a new and unfamiliar product.

Although the specialized network interface device circuitry 200 is shown in FIG. 4 integrated into the I/O controller hub integrated circuit 300, the specialized network interface device circuitry 200 is in another embodiment integrated into the graphics and memory controller hub integrated circuit 305 of the chip set. Integration in integrated circuits such as integrated circuit 305 further reduces the cost of distributing the enhanced function, because circuits required to distribute the enhanced function in embodiments such as an expansion card are not required when closely coupled with other integrated circuits, such as memory controller hub integrated circuit 305. Examples of functions not required in a closely coupled design include the PCI bus unit, DMA engines, and local SDRAM, since these functions are either not required in such an integration, or may share resources available in the integrated circuit containing the enhanced function.

More than one enhanced function can be offered. For example, for an additional enhancement more would be paid beyond an amount at which initial enhanced functionality is offered. Advanced port aggregation and/or load balancing features can be one such additional enhanced functionality offer. By conglomerating different sets of enhanced functions, multiple tiers of functionality can be offered, each tier being offered at a different price.

The above-described method of selectively enabling an enhanced function is also applicable to many types of electronic devices. Pairs of electronic device types and enhanced functions are set forth in Table 1 below for illustrative purposes. Many other pairs are possible. The method of receiving additional compensation for enabling an enhanced function is believed to be particularly applicable where there is an existing class of product having a base function, and where an enhanced function that costs money to provide (due to the requirement to provide specialized hardware) is anticipated to be desired in a significant percentage of those products in the near future. Situations where these conditions exist include situations where there are evolving standards, where there are changing performance requirements, and where the government or another body will be mandating new features or requirements.

TABLE 1

| Electronic Device Type | Enhanced Function |
|---|---|
| I/O Controller IC | Network Processing Acceleration |
| I/O Controller IC | IP Security |
| Video Processor IC | Video Acceleration |
| Network Interface Device | Network Processing Acceleration |
| Network Interface Device | IP Security |
| Memory Controller IC | Network Processing Acceleration |
| Memory Controller IC | Video Acceleration |
| Memory Controller IC | IP Security |

Although the present invention is described in connection with certain specific embodiments for instructional purposes, the present invention is not limited thereto. The capabilities code can have a “period of time left in trial” field. Microcode executing on the processor that is part of the network interface device may be responsible for decrementing this “period of time left in trial” value, and the network interface device may be programmed to disable itself after a predetermined large number of microcode downloads from the host. In one embodiment, the check code is a CRC code generated from the device ID and the capabilities code using a proprietary polynomial. The enhanced function that is selectively enabled need not relate to networking and need not be a TCP offload function. The manner of enabling the enhanced function need not involve a license manager program, a license key, an upgrade utility program, or writing a capabilities code into a nonvolatile memory on the electronic device. Accordingly, various modifications, adaptations, and combinations of various features' of the described embodiments can be practiced without departing from the scope of the invention as set forth in the following claims.

What is claimed is:

1. A method, comprising:
(a) supplying an electronic device to a user, the electronic device as supplied being capable of performing a base function, the electronic device comprising specialized hardware that allows the electronic device to perform an enhanced function, wherein the electronic device can be controlled such that the electronic device can perform the enhanced function, wherein the electronic device as supplied is controlled so that the electronic device cannot perform the enhanced function; and
(b) after the electronic device is supplied to the user, and only if an agreement is reached to receive additional compensation from the user, then enabling the electronic device to perform the enhanced function.

2. The method of claim 1, wherein the electronic device stores a capabilities code, the capabilities code determining whether the electronic device is enabled to perform the enhanced function, and wherein the enhanced function is a TCP offload function.

3. The method of claim 1, wherein the electronic device is an integrated circuit, wherein the specialized hardware is a network interface device circuit, wherein the enhanced function is a network processing acceleration function, and wherein the integrated circuit is taken from the group consisting of: an I/O controller integrated circuit, and a memory controller integrated circuit.

4. The method of claim 1, wherein the electronic device is supplied to the user in (a) pursuant to an agreement by the user to pay a first amount of compensation, and wherein the user agrees to pay the additional compensation in (b) in return for being able to use the electronic device to perform the enhanced function.

5. The method of claim 1, wherein the electronic device is supplied in (a) to a third party other than the user such that the third party pays a first amount of compensation, and wherein the third party in turn supplies the electronic device to the user, and wherein the user agrees to pay the additional compensation in (b) in return for being able to use the electronic device to perform the enhanced function.

6. The method of claim 1, wherein if the agreement in (b) is reached then a license key is provided to the user, and wherein the user uses the license key to control the electronic device in (b) such that the electronic device is enabled to perform the enhanced function.

7. The method of claim 6, wherein the license key allows a plurality of capability bits to be written to the electronic device.

8. The method of claim 1, wherein the electronic device is a network interface card (NIC), and wherein the enhanced function is a TCP offload function.

9. The method of claim 1, wherein the electronic device is an integrated circuit.

10. The method of Claim 1, wherein the electronic device is an integrated circuit, and wherein the enhanced function is a network protocol processing function.

11. A network interface device, comprising:
a port through which the network interface device receives a TCP/IP packet;
TCP offload circuitry; and
a memory storing a capabilities code, wherein if the capabilities code has a first value then the TCP offload circuitry performs TCP protocol processing on the TCP/IP packet such that a host processor coupled to the network interface device does substantially no TCP protocol processing on the TCP/IP packet, and wherein if the capabilities code has a second value then the network interface device passes the TCP/IP packet to the host processor such that the host processor does substantial TCP protocol processing on the TCP/IP packet.

12. The network interface device of claim 11, wherein the network interface device receives a second capabilities code and a first check code from the host processor, and wherein the network interface device calculates a second check code based at least in part on the second capabilities code, and wherein if the first check code received from the host processor does not match the second check code then the network interface device does not allow the capabilities code stored in the memory to be changed.
